(19) United States
(12) Patent Application Publication
(10) Pub. No.: US 2008/0096161 A1
(43) Pub. Date: Apr. 24, 2008

(54) Pneumatic dental care device

(76) Inventors: Joan Chiniquy Cain, Vero Beach, FL (US); Dennis Eugene Peters, Vero Beach, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/520,334

(22) Filed: Sep. 13, 2006

(51) Int. Cl. A61C 17/022

(52) U.S. Cl. 433/80

(57) ABSTRACT

A pneumatic dental care device for in-home use that is particularly suited for cleaning and providing prophylaxis of teeth, gingiva, and other oral tissue wherein pressurized air is directed into a user's oral cavity to clean teeth, remove oral debris and to both stimulate and massage gum line tissue. The compressed air, by means of a length of flexible tube, is delivered from a pressurized air source to a hand piece having both a nozzle tip and only one hand piece conduit. A control button disposed on the hand piece operably opens and closes a valve located within the hand piece, thereby allowing or stopping the outflow of compressed air from the nozzle tip of the hand piece. Additionally, a method of installing such a pneumatic dental care device for in-home use is disclosed.

### BACKGROUND

1. Field of the Invention

The present invention generally relates to a pneumatic dental prophylaxis device for cleaning and providing prophylaxis of teeth, gingiva, and other oral tissue and, more particularly, relates to a pneumatic dental prophylaxis device that is particularly suited to in-home use.

2. Background of the Invention

Medical science has demonstrated in the past that a thorough cleansing of teeth and gums greatly assists in protecting and promoting human health and comfort. When trapped debris and microorganisms (and their metabolic products) are removed from the cervical surfaces of the teeth next to gum margins, calculus accumulation or tartar is prevented since the inorganic salts necessary for producing such accumulation will deposit and calcify only when the organic matrix of this deposit is present. When this removal process is accomplished by a fluid stream, the inherent cyclic pressure and relaxation results in increased circulation in the underlying tissues thereby promoting healthier gums.

The role of specific micro-organisms, such as streptococcus mutants, in dental caries is well documented. Enzymes produced by such micro-organisms synthesize dextran from the sucrose passing through the mouth with food or drink resulting in the formation of dental plaque and dental caries.

Dental caries is the decay of teeth caused by demineralization of the enamel surface with organic acids produced by bacteria which adhere to teeth surfaces.

The oral regions of the mouth require frequent and periodic care that includes brushing and the like. Prior art has developed various devices to direct pressurized fluid into oral regions of the mouth in streams or pulses to provide for irrigation of the mouth and its cleaning. Further, individuals utilizing oral braces and the like utilize fluid directed cleaning to provide for proper massaging and cleaning about the brace area.

Air syringes and air-water syringes have been used by dentists and qualified dental technicians in conjunction with a wide variety of dental procedures, such as the routine cleaning of teeth and filling of cavities. While treating a patient, it is often necessary to clear the work area within the patient's mouth of waste material utilizing a syringe which produces a controlled spray of pressurized water or air, or both simultaneously, such that the air atomizes the water.

In typical usage, the dentist or dental technician grasps the handle portion of the syringe, inserts the nozzle portion into the open mouth or oral cavity of the patient, and then manipulates the syringe while simultaneously operating the air or water control buttons so that jets of air and/or water (or a mist formed by depressing both buttons) can be directed, as desired, at any selected tooth or gum portions within the oral cavity for any number of purposes, such as using the water jet for flushing away blood and/or particulate matter, or using the air jet for drying a desired area within the oral cavity.

While oral syringes are known to be of great assistance and value for loosening debris adhering to and/or trapped between the teeth in a clinical dental environment, their domestic utilization has heretofore been severely curtailed as a result of their complexity, costliness and the fact that they have been difficult to use and control. Perhaps more importantly, for such devices to achieve general household acceptance, they must be able to be produced on a smaller scale to fit within the bathrooms of domestic users, allowing for convenient daily use within the home.

Air Force Inc. of Holland, Mich. sells a product called the Dental Air Force. This system uses air mixed with water and dental cleaner (sodium bicarbonate) to remove food and plaque off the teeth. Air delivers cleaner into tiny spaces between teeth and along the gums. Air and cleaner are sprayed from the end of a slim tip to remove plaque from the oral cavity.

Waterpik Technologies, Inc. markets several water jet products for removal of dental plaque, in addition to minimizing gum line complication such as bleeding and gingivitis. Such Waterpik products distinguish themselves by solely utilizing a pressurized water stream to achieve the oral cleaning results of their products.

Deldent Ltd. discloses a series of dental products which appear to be for use by dental professionals and not by people in their private homes. Deldent Ltd. sells several varieties of dental air polishing units available for view on the company web site.

U.S. Pat. App. No. 2004/0202980 discloses a dental prophylaxis for compressed air delivery of abrasive and non-abrasive components to the oral cavity of a human.

U.S. Pat. No. 4,286,949 discloses a portable dental apparatus utilizing a compressor controlled by a foot pedal for operating high and low speed dental drills, a three-way syringe and a high volume suction device.

U.S. Pat. No. 5,297,962 discloses a dental cleaning device for removing food debris from between teeth wherein the compressed air is supplied from a cylinder small enough for the device to be carried in a pocket or handbag.

U.S. Pat. No. 6,884,069 discloses an oral care device having two conduits for conducting both air and a slurry, respectively, to an oral cavity of a human.

U.S. Pat. No. 6,964,569 discloses a pneumatic dental care device for cleaning teeth by means of a combination of air, liquid and powder at high pressure.

WO 99/48613 discloses a method of generating a flow of gas through a tube wherein the gas flow may be started and stopped by starting and stopping the gas compressor via a switching means.

As can be seen from the above examples of prior art, the principal direction of technology in this field has been toward devices which are better suited for use in the professional dental office where the costs of the equipment necessary for providing compressed air and water are more easily afforded and recovered. Additionally, the prior devices can be cumbersome since they may require the use of specially prepared abrasives, an air/powder mixture, water/powder suspension or the use of air-water three way dental syringes.

The examples of the prior art, while effective in a limited dental clinic environment, fail to provide for the smaller scale, convenient daily in-home use capabilities of the present invention, and in this respect, the present invention substantially fulfills this need.

### SUMMARY

The present inventive device is a tooth-cleaning device that can be used privately in the home to enhance and improve the efficiency of dental cleaning and oral hygiene to a far greater extent than devices known within the home-use dental art. The present inventive device is a household appliance in which compressed air is used to remove plaque, tartar and/or debris from a user's mouth. The device is novel in that it gives a private user the possibility of cleaning their teeth at home in a way that previously only a dentist could do, thus enabling the user to reduce the number of visits he or she makes to the dentist. Thus, each dental visit will be less comprehensive, faster and thus cheaper. Regular use of the device also means that it is possible to maintain cleaner, whiter and healthier teeth in the periods between regularly scheduled dental visits.

The present invention discloses a pneumatic dental care device for cleaning and providing prophylaxis of teeth, gingiva, and other oral tissue, comprising, a compressed air source having a power source, a flexible tubing for conducting compressed air, wherein a proximal end of the flexible tubing is connected to the compressed air source, a hand piece connected to a distal end of the flexible tubing, wherein the hand piece comprises only one hand piece conduit therein for conveying compressed air from the flexible tubing through the hand piece for the outflow of compressed air, an air valve within the hand piece, wherein the air valve is capable of opening and closing the only one hand piece conduit within the hand piece, and an air control button disposed on the hand piece and in operable communication with the air valve, wherein the air control button operates to open and close the air valve.

A method of installing the in-home pneumatic dental care device for cleaning and providing prophylaxis of teeth, gingiva, and other oral tissue is also encompassed by the disclosure of the present invention.

The present invention resides not in any one of these features per se, but rather in the particular combination of all of them herein disclosed and claimed and it is distinguished from the prior art in this particular combination of all of its structures for the functions specified.

### BRIEF DESCRIPTION OF THE DRAWINGS

FIG. 1 is an illustration of the assembled components of the present invention.

FIG. 2 is an illustration of one embodiment of the present invention installed under a sink in a domestic user's bathroom.

### DETAILED DESCRIPTION

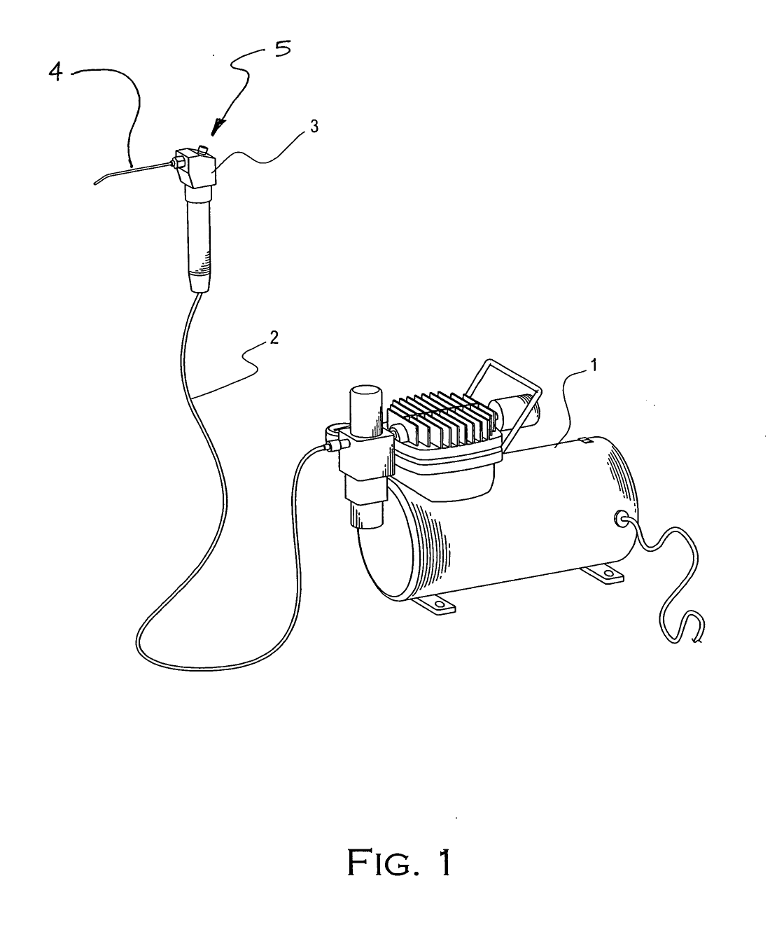

FIG. 1 depicts an embodiment of a pneumatic dental prophylaxis device for in-home use that is particularly suited for cleaning and providing prophylaxis of teeth, gingiva, and other oral tissue. Tooth decay, gingivitis and periodontal disease are dental conditions that may occur and arise between routinely scheduled visits to the dentist. Therefore, an effective and convenient in-home dental prophylaxis device, such as the present invention, is needed to allow everyday users to maintain proper oral hygiene on a routine daily basis. Such a device incorporates an air compressor unit 1 and a hand piece 5 attached to air compressor unit 1 by a length of flexible tubing 2. The device is capable of removing plaque and debris found on the teeth, between the teeth and around the gum line. Furthermore, the pneumatic dental prophylaxis device may be adapted to provide high, medium, low, or no (0) pressures depending upon the needs of the particular application.

Conventional systems for producing a compressed air source comprise a compressor and a pressure tank to which pressurized air is delivered from the compressor. The function of the compressor is controlled in dependency of the pressure in the tank so as to maintain the air pressure in the pressure tank substantially at a desired level. Such a conventional system comprises air separators and valves which must be able to close tightly.

The in-home pneumatic dental care device of the present invention preferably comprises an electrical air compressor unit 1 capable of providing compressed air via a length of flexible tubing 2. The electrical air compressor unit 1 is essentially comprised of a conventional compressor and an electrical drive motor associated with the compressor.

Being well known in the art, air pressure regulators, air filters, water traps and pressure gauges are additional helpful components. An air pressure regulator sets the air pressure going to flexible tubing 2. An air filter and a water trap are disposed within the compressed air line to ensure proper and adequate particulate filtering and moisture removal of the compressed air before the air enters a user's mouth, see U.S. Pat. No. 4,741,697, hereby incorporated by reference. An attached air pressure gauge allows convenient display of the air pressure, in pounds per square inch (PSI), of the compressed air.

By operating the device at an air pressure of between about 20 PSI to about 50 PSI when the hand piece 5 is used two or more feet from the air compressor unit 1, teeth cleaning can be accomplished in the home in a safe manner without causing damage in the oral cavity.

The air compressor unit 1 further includes a power supply cord and adapter, which is configured to be operably received in any one of a plurality of standard power outlets available around the world. Alternatively, the air compressor unit 1 may be powered by batteries disposed on the air compressor unit 1.

Air compressor unit 1 may further incorporate the well known “on-demand” features found on many compressors within the art. Such well known beneficial features include automatic shutoff (which provides for operation of air compressor unit 1 only when hand piece 5 is being used), instantly available on-demand air, reduced noise, extended compressor life, cooler operating temperatures, reduced running time, prevention of heat-related moisture buildup, and avoidance of common compressor overheating problems.

The device may further comprise a solenoid controlled valve connected to the compressor-motor to relieve pressure in the system when the compressor-motor is turned off. A safety relief valve may also be connected in the main air line leading from the compressor of the unit. Operating air pressure for all components is delivered by the compressor unit 1 through flexible tubing 2.

A conventional syringe for cleaning debris from a patient or user's teeth and mouth comprises a hand piece 5, having a handle portion 3 attached to the distal end of flexible tube 2 and a nozzle tip 4 attached to handle portion 3 of hand piece 5 for insertion into the oral cavity of a patient or user to guide the water and/or air therein. In some cases, as with the present invention, such a syringe is designed only to provide either air or water, but not both, and in such cases there ordinarily is a single control button on the top of handle portion 3 for actuating the stream of compressed air. Syringes providing both water and air ordinarily include two separate buttons adjacent one another on top of the body which may be pressed alternatively either to actuate the water or the air, or they may be pressed simultaneously to actuate both fluids and produce atomization of the water. To conduct the compressed air, flexible tubing 2 is attached at its distal end to hand piece 5 and at its proximal end to a source of compressed air (i.e. air compressor unit 1).

Nozzle tip 4 must be securely held by the handle portion 3 to prevent it from being ejected into the patient's mouth, and it must be clean to avoid spreading disease. The nozzle tip can be retained in the handle portion by a variety of known means, which include but are not limited to, a retaining collar attached to a threaded stem in handle portion 3, which compresses an O-ring into a groove on nozzle tip 4, see U.S. Pat. No. 4,975,054 and U.S. Pat. No. 4,149,315, both hereby incorporated by reference. Between uses of hand piece 5, nozzle tip 4 should be removed from handle portion 3 and sterilized or be replaced with a sterile nozzle tip 4.

Nozzle tip 4 may have any one of a plurality of shapes, delivery streams, and applications. By way of non-limiting example, removable nozzle tip 4 may include a brush, a sponge or rubber scraper, a tongue scraper, or other known periodontal aid. Removable nozzle tip 4 is preferably a quick change, 360 degree rotating individual user tip, which takes on different shapes depending upon the embodiment. An in-home user directs the controlled flow of air by aiming the discharge end of nozzle tip 4. Dental nozzle tips 4 generally have a bend between the connection and the distal discharge end to provide ergonomic aiming of the dispensed fluids. It should be understood that hand piece 5 and nozzle tip 4 may be one self-contained disposable unit or an assembled unit.

Typically in an air-water dental syringe, two passageways are provided, both of which extend through the handle portion 3 and the nozzle tip 4 so that pressurized air and water can be introduced into such passageways, respectively, and emitted from the extending end of the nozzle tip 4 at a predetermined flow rate. A separate control button for each of the two passageways is disposed on the handle portion 3 of the syringe so that the user can, by pressing such a control button, operate a control valve in each passageway to thereby control the flow of the water and the air which is emitted from the nozzle tip 4. The present invention pertains to an air-only dental hand piece 5, thus comprising, only one control button, only one valve, and only one hand piece conduit within hand piece 5 for the oral application of compressed air. The present invention does not incorporate water, slurry or any powders. Thus, only one conduit formed within hand piece 5 is contemplated.

The present invention provides a pneumatic dental care device comprising a hand piece 5 coupled to an air compressor unit 1 by means of flexible tubing 2. Air compressor unit 1 comprises an air input in communication with the general atmosphere and an air output connected to the proximal end of flexible tubing 2. Air compressor unit 1 further comprising an air pressure regulator, air filter, water trap and pressure gauge connected to the air pressure source and arranged to produce a regulated air pressure at the air output. Distal end of flexible tubing 2 is connected to hand piece 5. Hand piece 5 comprises handle portion 3 and nozzle tip 4. Handle portion 3 houses an air valve wherein a control button is operably connected to the air valve to open and close the air valve. With the air output connected to the proximal end of flexible tubing 2 and the distal end of flexible tubing 2 connected to the nozzle tip 4 via hand piece 5 and handle portion 3, the arrangement provides that, when the regulated pressure appears at the air output, the air pressure source is connected to nozzle tip 4 for expulsion of the pressurized air.

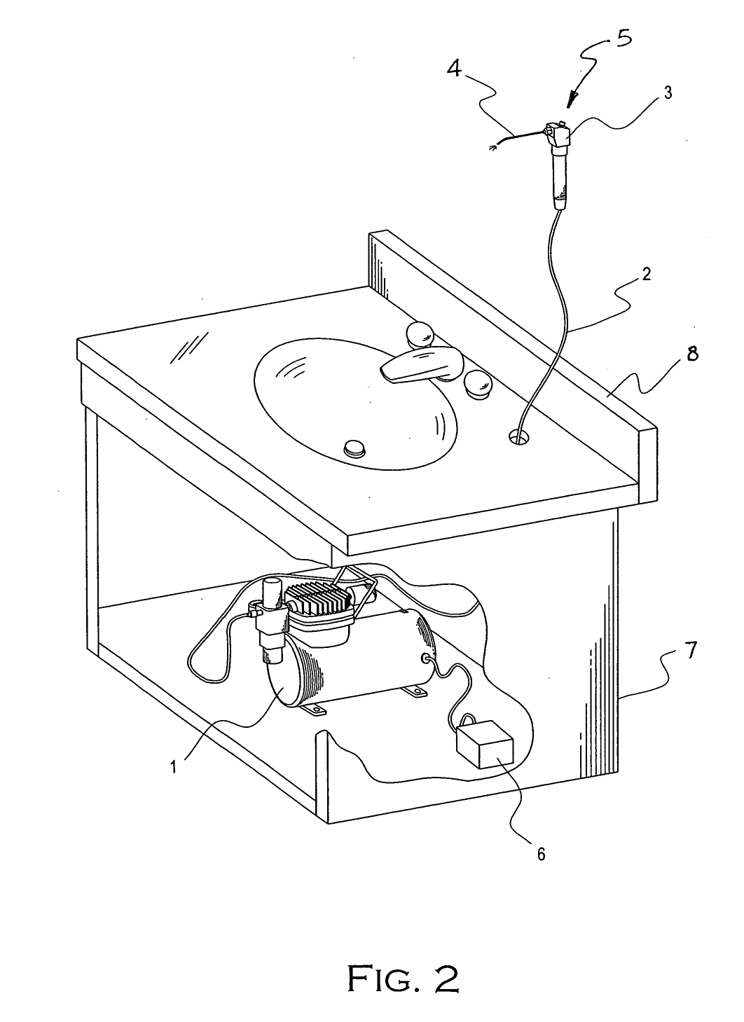

The present invention, in FIG. 2, further includes a method of installing an in-home pneumatic dental care device for cleaning and providing prophylaxis of teeth, gingiva, and other oral tissue, comprising the steps of, placing an on-demand compressed air source 1 within a residential home bathroom vanity 7, wherein the on-demand compressed air source 1 comprises a compressor and an electrical drive motor associated with said compressor, with the on-demand compressed air source further comprising a power cord 6 connected to an electrical wall outlet, an air regulator, an air filter, a water trap, and a pressure gauge. Next, connect the proximal end of flexible tubing 2 to the compressed air source 1. Then, pass a distal end of the flexible tubing 2 through an aperture defined by a bathroom sink counter top 8. Finally, connect the distal end of the flexible tubing 2 to a hand piece 5, wherein the hand piece comprises a handle portion 3 for manual gripping, a nozzle tip 4 for the outflow of compressed air, and only one hand piece conduit extending within both the handle portion 3 and the nozzle tip 4 for conveying the compressed air from the flexible tubing 2 to the nozzle tip 4. The handle portion 3 further comprises an air valve within the handle portion 3, wherein the air valve is capable of opening and closing the only one hand piece conduit within the handle portion 3. Additionally, the handle portion 4 further comprises an air control button disposed on the handle portion 4 of the hand piece 5, wherein the air control button is in operable communication with the air valve, and the air control button operates to open and close the air valve during use. As known by one of ordinary skill in the art, the specific order of the installation steps is not critical, thus allowing the individual steps of the present invention to be transposed within the broadest reasonable scope of interpretation.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A pneumatic dental care device utilizing compressed air for cleaning and providing prophylaxis of teeth, gingiva, and other oral tissue, comprising:
a compressed air source having a power source;
a flexible tubing for conducting said compressed air, wherein a proximal end of said flexible tubing is connected to said compressed air source;
a hand piece connected to a distal end of said flexible tubing, wherein said hand piece comprises only one hand piece conduit therein for conveying said compressed air from said flexible tubing through said hand piece for the outflow of said compressed air;
an air valve within said hand piece, wherein said air valve is capable of opening and closing said only one hand piece conduit within said hand piece; and
an air control button disposed on said hand piece and in operable communication with said air valve, wherein said air control button operates to open and close said air valve.

2. The pneumatic oral care device of claim 1, wherein said hand piece further comprises a handle portion for manual gripping and a nozzle tip, said only one hand piece conduit extending within both said handle portion and said nozzle tip for conveying said compressed air from said flexible tubing to said nozzle tip for outflow of said compressed air.

3. The pneumatic oral care device of claim 2, wherein said air valve is located within said handle portion of said hand piece.

4. The pneumatic oral care device of claim 3, wherein said air control button is disposed on said handle portion of said hand piece.

5. The pneumatic oral care device of claim 4, wherein said compressed air source comprises a compressor and an electrical drive motor associated with said compressor.

6. The pneumatic oral care device of claim 5, wherein said compressed air source provides pressurized air on-demand when in use and automatically shuts off when not in use.

7. The pneumatic oral care device of claim 6, wherein said compressed air source further comprises an air regulator, an air filter, a water trap, and a pressure gauge.

8. The pneumatic oral care device of claim 7, wherein said power source comprises a power cord in communication with an electrical outlet.

9. The pneumatic oral care device of claim 7, wherein said power source comprises batteries.

10. A pneumatic dental care device for cleaning and providing prophylaxis of teeth, gingiva, and other oral tissue, comprising:
an on-demand compressed air source comprising a compressor and an associated electrical drive motor, wherein said on-demand compressed air source further comprises an electrical power cord, an air regulator, an air filter, a water trap, and a pressure gauge;
a flexible tubing, wherein a proximal end of said flexible tubing is connected to said compressed air source;
a hand piece connected to a distal end of said flexible tubing, wherein said hand piece comprises a handle portion for manual gripping, a nozzle tip for the outflow of said compressed air, and only one hand piece conduit extending within both said handle portion and said nozzle tip for conveying said compressed air from said flexible tubing to said nozzle tip;
an air valve within said handle portion, wherein said air valve is capable of opening and closing said only one hand piece conduit within said handle portion; and
an air control button disposed on said handle portion of said hand piece, said air control button in operable communication with said air valve, wherein said air control button operates to open and close said air valve.

11. A method of installing an in-home pneumatic dental care device for cleaning and providing prophylaxis of teeth, gingiva, and other oral tissue, comprising the steps of:
placing an on-demand compressed air source within a residential home bathroom vanity, wherein said on-demand compressed air source comprises a compressor and an electrical drive motor associated with said compressor, said on-demand compressed air source further comprising a power cord connected to an electrical wall outlet, an air regulator, an air filter, a water trap, and a pressure gauge,
connecting a proximal end of a flexible tubing to said compressed air source;
passing a distal end of said flexible tubing through an aperture defined by a bathroom sink counter top; and
connecting said distal end of said flexible tubing to a hand piece, wherein said hand piece comprises a handle portion for manual gripping, a nozzle tip for the outflow of said compressed air, and only one hand piece conduit extending within both said handle portion and said nozzle tip for conveying said compressed air from said flexible tubing to said nozzle tip, said handle portion further comprising an air valve within said handle portion, wherein said air valve is capable of opening and closing said only one hand piece conduit within said handle portion; and said handle portion further comprising an air control button disposed on said handle portion of said hand piece, wherein said air control button is in operable communication with said air valve, with said air control button operating to open and close said air valve.
